(19) United States
(12) Patent Application Publication
(10) Pub. No.: US 2009/0277885 A1
(43) Pub. Date: Nov. 12, 2009

(54) LASER PROCESSING APPARATUS AND LASER PROCESSING METHOD

(75) Inventors: Kazuo NAKAMAE, Yokohama-shi (JP); Motoki KAKUI, Yokohama-shi (JP); Shinobu TAMAOKI, Yokohama-shi (JP)

Correspondence Address: VENABLE LLP, P.O. BOX 34385, WASHINGTON, DC, 20043-9998, US

(73) Assignee: SUMITOMO ELECTRIC INDUSTRIES, LTD., Osaka-shi (JP)

(21) Appl. No.: 12/464,505

(22) Filed: May 12, 2009

(30) Foreign Application Priority Data
May 12, 2008 (JP) P2008-124990

(51) Int. Cl. B23K 26/04

(52) U.S. Cl. 219/121.61

(57) ABSTRACT

The present invention relates to a laser processing apparatus having a structure for effectively processing of objects by condensing a laser beam, and a laser processing method. A laser processing apparatus comprises a common mount surface on which plural objects are disposed in an array, a light source, a lens the reflection direction of which is changeable, and a condensing direction modifier. A laser beam from the light source arrives at the lens through a galvano-mirror. Herein, the galvano-mirror is arranged such that the reflection position thereof agrees with the front focal position of the lens. As the galvano-mirror reflects a laser beam toward the lens while the reflection direction is changed, the arriving position of the laser beam is scanned on the entrance surface of the lens. The condensing direction modifier modifies, according to the irradiation position of the laser beam arrived from the lens, an exit direction of the laser beam.

### BACKGROUND OF THE INVENTION

1. Field of the Invention

The present invention relates to a laser processing apparatus having a structure for desired processing of objects by the use of a laser beam, and a laser processing method.

2. Related Background Art

By irradiating a surface of an object to be processed with a laser beam, an irradiation area of the object to be processed can be processed. Such a laser beam processing is versatile. For example, FAYb-laser-marker LP-V series brochure, published by SUNX Limited in November 2005, No. CJ-LPV10-I-10 (Document 1), discloses a technology of a laser marker for printing on the surface of a processing object.

### SUMMARY OF THE INVENTION

The present inventors have examined conventional laser processing apparatuses, and as a result, have discovered the following problems.

That is, a conventional laser processing apparatus condenses a laser beam, in general, by using a condenser optical system, and processes an object which is disposed at the beam condensing position of the condenser optical system. A lens and the like, for example, are used for a condenser optical system of a laser processing apparatus. In this case, a laser beam is condensed on the back focal plane of a lens. In other words, a condensed point of the laser beam corresponds to the focal point of the lens. Accordingly, when an irradiation area (the surface to be processed) of an object is present at a position different from the back focal plane of the lens, since the surface to be processed is irradiated with a laser beam in a state where the laser beam is not condensed, the object may be insufficiently processed. Further, in a case where the surface to be processed is not parallel with the back focal plane, the surface having an angle with respect to the back focal plane, since the irradiation intensity of a laser beam is smaller than on the back focal plane, this case also caused insufficient laser processing of an object.

The present invention has been developed to eliminate the problems described above. It is an object of the present invention to provide a laser processing apparatus having a structure for effectively processing an object to be processed and a laser processing method using the same.

A laser processing method according to the present invention performs a laser processing to plural objects disposed in an array on a common mount surface, and, for achieving the above-described object, comprises the disposing of the plural objects, the laser beam scanning, and the change of the condensing direction of the laser beam.

The plural objects are disposed at predetermined positions on the common mount surface, in a state where the plural objects are adjacent to each other. The laser beam from the light source is sequentially outputted onto the plural objects along a vertical direction to the common mount surface, while the laser beam is scanned along a horizontal direction to the common mount surface. A condensing direction of the vertically outputted laser beam from is changed by a condensing direction modifier disposed over each of the plural objects. At this time, the condensing direction of the laser beam is changed according to a position where the laser beam is outputted from the condensing direction modifier.

A laser processing apparatus according to the present invention respectively processes plural objects arranged in an array on a predetermined flat surface, by irradiating the plural objects with a laser beam, while scanning n irradiation position of the laser beam. In concrete terms, the laser processing apparatus according to the present invention, for achieving the above-described object, comprises a common mount surface, a light source, a galvano-scannner as a scanning system, a condenser optical system, and a condensing direction modifier.

On the common mount surface, plural objects are arranged in a state where the plural objects are adjacent to each other. The galvano-scanner outputs the laser beam from the light source toward the common mount surface, while scanning the laser beam along a horizontal direction to the common mount surface. The condenser optical system is provided between the galvano-scanner and the common mount surface. Also, the condenser optical system condenses the laser beam arrived from the galvano-scanner such that the laser beam is outputted toward the common mount surface along a vertical direction to the common mount surface. The condensing direction modifier is provided between the condenser optical system and the common mount surface. The condensing direction modifier, according to a position where the laser beam arrives from the condenser optical system, outputs the arrived laser beam along a direction that is different from a principal beam direction of the arrived laser beam.

In accordance with a laser processing apparatus according to the present invention, by arranging a condensing direction modifier between a condenser optical system and objects, as described above, a laser beam can be condensed at a condensed point that is different from the condensed point by the condenser optical system, according to the position where the laser beam arrives. Thus, even in a case where the surface to be processed of an object is present at a position different from the back focal point of the condenser optical system, the laser processing apparatus is capable of effectively condensing a laser beam onto the surface to be processed. Further, by arranging the condensing direction modifier, effective laser beam irradiation can be realized in a wide range, which enables effective laser beam processing of objects.

In a laser processing apparatus according to the present invention, a condensing direction modifier preferably has a uniform refractive index distribution. In this case, the thickness of the condenser optical system along the optical axis direction thereof is different according to the position where a laser beam from a mirror arrives. Thus, in a case where the refractive index of a condensing direction modifier is uniform while the thickness of a condenser optical system along the optical axis direction thereof is different according to the position where a laser beam is inputted, the laser beam that is outputted from the condensing direction modifier is condensed at a condensed point, the distance of which from the condenser optical system is different according to the input position. Further, the condensing direction modifier can be easily formed from a material, the refractive index of which is uniform, and a laser beam can be easily condensed at a position which is different from the position of the back focal plane of the condenser optical system.

Still further, the condensing direction modifier has a first surface (the laser beam entrance surface) facing the condenser optical system and a second surface (the laser beam exit surface) opposing the first surface. Particularly, there is variation in the shape of at least a part of the second surface, for modifying the principal optical direction of a laser beam arrived from the condenser optical system. For example, at least a part of the second surface is preferably formed with a prism shape including two surfaces having respective different angles with respect to the reference surface of the second surface. Further, at least a part of the second surface may have a shape of a concave lens. Still further, at least a part of the second surface may have a shape of a Fresnel lens.

In a case where the condensing direction modifier has a shape as described above, regarding a laser beam having passed through the condensing direction modifier, not only the condensed position is different from the position of the back focal plane of the condenser optical system, but also the irradiation direction of the laser beam is modified. Thus, more effective laser processing is allowed on the surfaces to be processed of objects.

### BRIEF DESCRIPTION OF THE DRAWINGS

FIG. 1 is a diagram illustrating a constitution in a first embodiment of a laser processing apparatus according to present the invention;

FIG. 2 is a diagram illustrating a constitution in a second embodiment of a laser processing apparatus according to the present invention; and

FIG. 3 is a diagram illustrating a constitution in a third embodiment of a laser processing apparatus according to the present invention.

### DESCRIPTION OF THE PREFERRED EMBODIMENTS

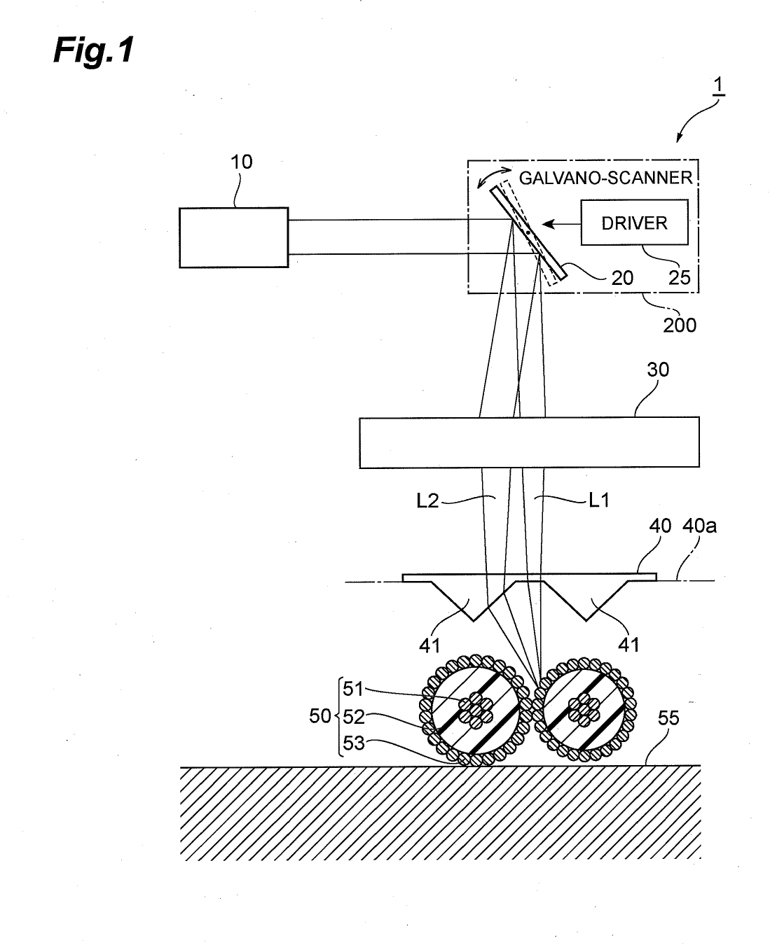

In the following, embodiments of laser processing apparatus and laser processing method according to the present invention will described in detail with reference to FIGS. 1 to 3. In the description of the drawings, identical or corresponding components are designated by the same reference numerals, and overlapping description is omitted.

### First Embodiment

A laser processing apparatus and laser processing method according to a first embodiment will be described. FIG. 1 is a diagram illustrating a constitution in the first embodiment of a laser processing apparatus according to the present invention. The laser processing apparatus 1, shown in FIG. 1, processes the surfaces of objects to be processed 50 by irradiating the objects 50 with a laser beam. In concrete terms, the laser processing apparatus 1 comprises a laser light source 10, a galvano-scanner 200 as a scanning system, a lens 30 being a condenser optical system, a condensing direction modifier 40, and a common mount surface 55. The galvano-scanner 200 includes a galvano-mirror 20 and a driver 25 that changes the reflection angle of the galvano-mirror 20. The condensing direction modifier 40 has a first surface (the laser beam entrance surface) facing the lens 30 and a second surface (the laser beam exit surface) opposing the first surface, wherein a part (a part parallel with the first surface) of the second surface defines a reference surface 40a of the condensing direction modifier 40. The objects 50 are disposed on a flat surface that is perpendicular to the optical axis direction of the lens 30, namely, on the common mount surface 55, in a state where the objects 50 are adjacent to each other.

The laser light source 10 outputs the laser beam for processing each of the objects 50. The laser light source 10 is, for example, a YAG laser light source or an optical fiber laser light source containing an optical fiber, as an optical amplifying medium, for which an Yb element is added in an optical waveguide region. As the laser light source 10, a laser marker made by SUNX Limited or the like is used, for example. The laser beam is outputted toward the galvano-mirror 20 by the laser light source 10.

The galvano-mirror 20 included in the galvano-scanner 200 reflects a laser beam outputted from the laser light source 10, and introduces the laser beam toward the lens 30. The galvano-mirror 20 has a structure that variably changes the reflection direction. Accordingly, the driver 25 changes the reflection direction of the galvano-mirror 20 so that the irradiation position of the laser beam outputted from the laser light source 10 is scanned on the objects 50. Herein, the galvano-mirror 20 is disposed at the position of the front focal point of the lens 30, and reflects the laser beam at the position of the front focal point of the lens 30.

The lens 30 as a condenser optical system receives the laser beam reflected by the galvano-mirror 20, and condenses the laser beam toward the object 50. The optical axis direction of the lens 30 is orthogonal to the common mount surface 55 on which the objects 50 are disposed. Further, the position of front focal point of the lens 30 is arranged to be at the reflecting position of the galvano-mirror 20. As the lens 30, an fθ lens is used. The fθ lens makes the exit direction of the laser beam perpendicular to the lens surface, regardless of the entrance direction or entrance angle of the laser beam at the entrance position of the laser beam. The lens 30 may be modified into a structure with plural superposed lenses, or the like.

The condensing direction modifier 40 is disposed between the lens 30 and the objects 50. This condensing direction modifier 40 receives the laser beam outputted from the lens 30, and condenses the laser beam to a condensed point, the distance of which from the lens 30 along the optical axis direction is different according to the position (the entrance position of the laser beam) where the laser beam has arrived. In concrete terms, the condensing direction modifier 40 has a structure where prism sections 41 are arranged at constant intervals on silica glass (on the reference surface 40a) in a shape of a flat plate. The intervals at which the prism sections 41 are disposed depend on the shape of the objects 50. In the first embodiment, the interval between the prism sections 41 is 310 μm. Further, each prism section 41 has two surfaces having angles which are different from each other with respect to the reference surface 40a.

On the other hand, as an object 50, a coaxial cable is arranged. This object 50 is constituted by central conductors 51, inner insulators 52, and shield wires 53 in this order from the center. The central conductors 51 and the shield wires 53 are respectively comprised of conductive metals such as a tinned copper alloy, for example. The inner insulators 52 are comprised of an insulating resin such as PFA or PET, for example. The object 50 has a diameter of approximately 240 μm. Further, the outside of the shield wires 53 of this object 50 may be covered with a coating insulator. In FIG. 1, two objects 50 are disposed with the same height and at an interval of 310 μm therebetween. As the method of disposition herein, each object 50 may be disposed in a V-shaped recession of a processing table formed with V-shaped grooves. Further, as shown in FIG. 1, the objects 50 are disposed such that the vertexes of the prism sections 41 in the condensing direction modifier 40 and the surface tops of the plural objects 50 of processing disposed on the common mount surface 55 are aligned.

Here, the laser processing method according to the first embodiment will be described, referring to FIG. 1. The description below will be made focusing on the operation of the condensing direction modifier 40, in other words, focusing on the state where a laser beam is condensed at a condensed point, wherein the distance of the condensed point from the lens 30 with respect to the optical axis direction is different, according to the position where the laser beam is inputted.

First, a laser beam L1 that does not pass through a prism section 41 of the condensing direction modifier 40 will be described. The laser beam L1 (a laser beam outputted from the laser light source 10) is reflected by the galvano-mirror 20 and then arrives at the lens 30. The laser beam L1 is outputted by the lens 30 such as to be condensed, and then enters the condensing direction modifier 40.

The condensing direction modifier 40 is comprised of a silica glass having a uniform refractive index distribution. The laser beam L1 having been inputted to the condensing direction modifier 40 goes through the condensing direction modifier 40, being refracted according to the refractive index of the silica glass. Then, this laser beam L1 exits from a flat plate part (the reference surface 40a that is not formed with a prism section 41) of the condensing direction modifier 40. Herein, since the refractive index of the condensing direction modifier 40 is greater than the atmospheric refractive index, the laser beam L1 outputted from the condensing direction modifier 40 is condensed at a position farther than the back focal plane of the lens 30 from the lens 30 with respect to the optical axis direction. Accordingly, the condensed point of the laser L1 can be modified to a position different from the back focal plane of the lens 30. In this specification, the condensed position of the laser beam means as a position where a spot diameter of the laser beam having passed through the lens 30 and the condensing direction codifier 40 becomes minimum.

Next, a laser beam L2 passing through a prism section 41 of the condensing direction modifier 40 will be described. The laser L2 shown in FIG. 1, which has been outputted from the laser light source 10, the same as the laser beam L1, is reflected by the galvano-mirror 20, and then arrives at the lens 30. The laser beam L2 is outputted by the lens 30 such as to be condensed, and then enters the condensing direction modifier 40.

Herein, since the condensing direction modifier 40 is comprised of a silica glass, the laser beam L2 inputted to the condensing direction modifier 40 travels through the condensing direction modifier 40, being refracted according to the refractive index of the silica glass. Further, the laser beam L2 travels to a prism section 41 of the condensing direction modifier 40. Then, the laser beam L2 is outputted from a face of the prism section 41. Herein, the face of the prism section 41 that outputs the laser L2 has an angle which is different from that of the face (the surface parallel to the reference surface 40a) where the laser beam L2 has entered. Accordingly, the output direction of the laser L2 outputted from the face of the prism section 41 is different from the optical axis direction of the lens 30. Further, since the refractive index of the condensing direction modifier 40 is greater than the atmospheric refractive index, the laser L2 outputted from the condensing direction modifier 40 is condensed at a position farther than the back focal plane of the lens 30 from the lens 30 with respect to the optical axis direction. Thus, the condensed position of the laser beam L2 is modified to a position that is different from the back focal plane of the lens 30.

Still further, the condensed point of the laser beam L2 outputted from the condensing direction modifier 40 is different, according to the thickness of the condensing direction modifier 40 with respect to the optical axis direction of the lens 30. In the first embodiment, the part where the laser L2 passes through has a larger thickness with respect to the optical axis direction of the lens 30, compared with the part where the laser beam L1 passes through. Accordingly, as shown in FIG. 1, the position where the laser beam L2 is condensed is farther from the lens 30, as compared with the position where the laser beam L1 is condensed. In such a manner, with the laser processing apparatus 1 in the first embodiment, laser beams can be condensed at positions which are different in the distance from the lens 30. Further, as in the case of the laser beam L2, the condensing direction of the laser beam can be modified by the condensing direction modifier 40. Consequently, as shown in FIG. 1, by disposing an object 50 in advance such that the side surface of the object 50 is at the condensed position of the laser beam L2, the side surface of the object 50 can be appropriately processed by the laser beam L2. Besides, the surface of the object 50 can be processed also by the laser L1 passing through the flat plate part of the condensing direction modifier 40.

As has been described above, in accordance with the first embodiment, the condensed position of a laser beam can be modified to a position that is different from the back focal plane of a lens, and further, even an object to be processed having a complicated shape can be irradiated in a state where a laser beam is condensed. Therefore, it is possible to sufficiently perform laser processing of desired objects 50.

### Second Embodiment

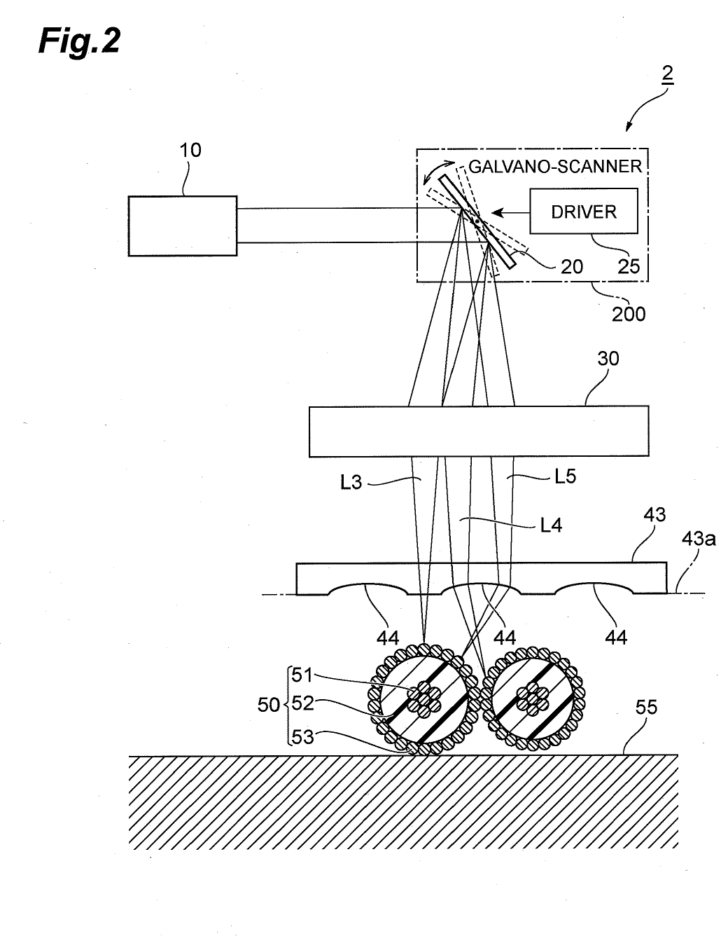

Next, a laser processing apparatus and a laser processing method in a second embodiment according to the present invention will be described. FIG. 2 is a diagram illustrating a constitution in the second embodiment of a laser processing apparatus according to the present invention. The laser processing apparatus 2, shown in FIG. 2, processes the surfaces of objects to be processed 50 by irradiating the objects 50 with a laser beam, the same as the laser processing apparatus 1 according to the first embodiment. In concrete terms, the laser processing apparatus 2 according to the second embodiment comprises a laser light source 10, a galvano-scanner 200 as a scanning system, a lens 30 being a condenser optical system, a condensing direction modifier 43, and a common mount surface 55. The galvano-scanner 200 includes a galvano-mirror 20 and a driver 25 that changes the reflection angle of the galvano-mirror 20. The condensing direction modifier 43 has a first surface (the laser beam entrance surface) facing the lens 30 and a second surface (the laser beam exit surface) opposing the first surface, wherein a part (a part parallel with the first surface) of the second surface defines a reference surface 43a of the condensing direction modifier 43. The objects 50 are disposed on a flat surface which is perpendicular to the optical axis of the lens 30, namely, on the common mount surface 55, in a state where the objects 50 are adjacent to each other. The laser processing apparatus 2 according to the second embodiment has the similar constitution as that in the first embodiment, except that the shape of the condensing direction modifier 43 is different from that of the condensing direction modifier 40 in the first embodiment.

That is, the condensing direction modifier 43 of the laser processing apparatus 2 according to the second embodiment is comprised of a silica glass, having a uniform refractive index distribution. Differently from the condensing direction modifier 40 in the first embodiment, the condensing direction modifier 43 is provided with concave lens sections 44 at constant intervals on the second surface to be the reference surface 43a. The disposition intervals of these concave lens sections 44 are 310 μm, the same as the first embodiment in that the disposition intervals are made equal to the disposition interval of the objects 50.

Here, the laser processing method according to the second embodiment will be described, referring to FIG. 2. The description below will be made focusing on the operation of the condensing direction modifier 43, in other words, focusing on the state where a laser beam is condensed at a condensed point, wherein the distance of the condensed point from the lens 30 with respect to the optical axis direction is different, according to the position where the laser beam is inputted.

First, a laser beam L3 will be described. The laser beam L3 (a laser beam outputted from the laser light source 10), shown in FIG. 2, is reflected by the galvano-mirror 20 and then arrives at the lens 30. The laser beam L3 is outputted by the lens 30 so as to be condensed, and then enters the condensing direction modifier 43.

The condensing direction modifier 43 is comprised of a silica glass. Consequently, the laser beam L3 inputted to the condensing direction modifier 43 travels through the condensing direction modifier 43, being refracted according to the refractive index of the silica glass. Then, this laser beam L3 is outputted from a flat plate part (corresponding to the reference surface 43a) of the condensing direction modifier 43. Herein, since the refractive index of the condensing direction modifier 43 is greater than the atmospheric refractive index, the laser beam L3 outputted from the condensing direction modifier 43 is condensed at a position farther than the back focal plane of the lens 30 from the lens 30 with respect to the optical axis direction. Accordingly, the condensed point of the laser beam L3 can be modified to a position different from the back focal plane of the lens 30.

Next, laser beams L4 and L5 which pass through concave lens sections 44 of the condensing direction modifier 43 will be described. The laser beams L4 and L5, shown in FIG. 2, are outputted from the laser light source 10, the same as the laser beam L3. Further, these laser beams L4 and L5 are reflected by the galvano-mirror 20, and then arrives at the lens 30. The laser beams L4 and L5 are outputted in a state where they are condensed by the lens 30, and enter the condensing direction modifier 43.

Herein, the condensing direction modifier 43 is comprised of a silica glass. Consequently, the laser beams L4 and L5 inputted to the condensing direction modifier 43 respectively travel through the condensing direction modifier 43, being refracted according to the refractive index of the silica glass. Then, the laser beams L4 and L5 travel to a concave lens section 44 of the condensing direction modifier 43, and are outputted from the condensing direction modifier 43. Herein, the surface of the concave lens section 44, from which the lasers L4 and L5 are outputted, have angles which are different from that of the face (the surface parallel to the reference surface 43a) where the laser beams L4 and L5 have entered. Accordingly, the output directions of the laser beams L4 and L5, which are outputted from the face of the concave lens section 44, are respectively different from the optical axis direction of the lens 30. Further, since the refractive index of the condensing direction modifier 43 is greater than the ambient refractive index, the laser beams L4 and L5, which are outputted from the condensing direction modifier 43, are condensed at positions farther than the back focal plane of the lens 30 from the lens 30 with respect to the optical axis direction. In such a manner, the condensed positions of the laser beams L4 and L5 can be modified to positions which are different from the back focal plane of the lens 30.

Still further, the condensed position of a laser beam is different according to the thickness, with respect to the optical axis direction of the lens 30, of the condensing direction modifier 43. Accordingly, the distances from the lens 30 to the condensed positions are respectively different between the laser beams L3, L4, and L5, wherein the laser beam L3 passes through the flat plate part of the condensing direction modifier 43, and the laser beams L4 and L5 pass through the concave lens section 44 of the condensing direction modifier 43.

As shown in FIG. 2, the condensing direction modifier 43 is disposed such that the parts in a shape of a flat plate of the condensing direction modifier 43 are positioned above the top surface portions of the objects 50, and the concave lens sections 44 are positioned above the side surface portions of the objects 50. Thus, the following effects can be obtained. That is, the side surfaces of the objects 50 can be processed by the laser beams L4 and L5 passed through a concave lens section 44. Further, as the condensing directions of the laser beams L4 and L5 can be modified by the condensing direction modifier 43, the side surfaces of the objects 50 can be effectively processed. Still further, the top surfaces of the objects 50 can be processed by a laser L3 having passed through the part in the shape of a flat plate.

As has been described above, in accordance with the second embodiment, as the condensed position of a laser beam can be modified to a position that is different from the back focal plane of the lens, and further, objects having a complicated shape can also be irradiated in a state where a laser beam is condensed, desired objects 50 can be sufficiently laser-processed.

### Third Embodiment

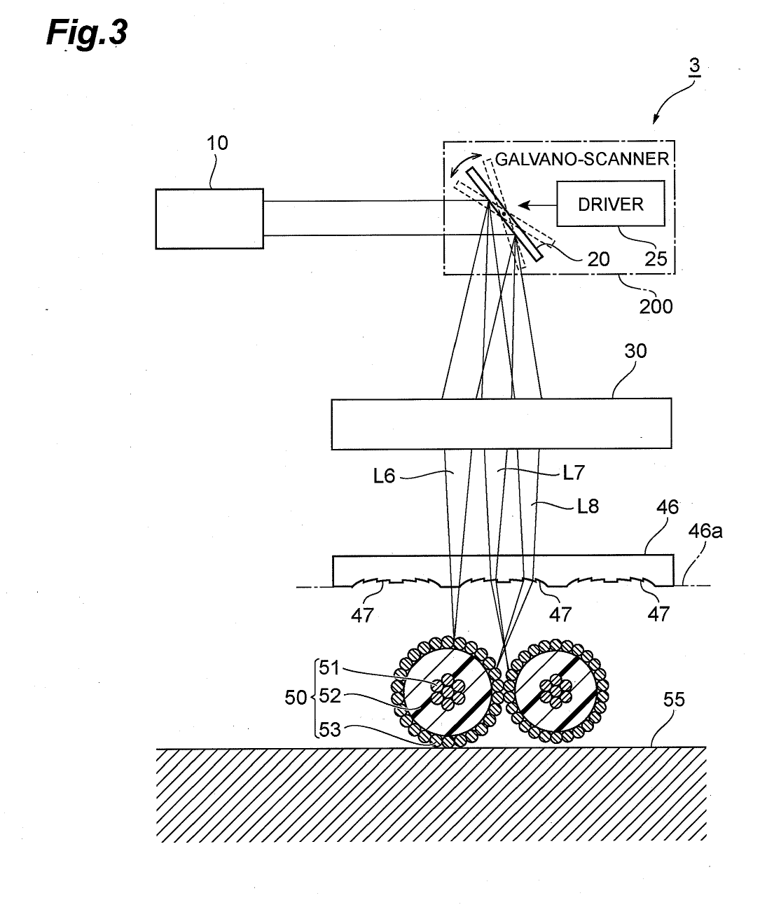

Next, a laser processing apparatus and laser processing method in a third embodiment according to the present invention will be described. FIG. 3 is a diagram illustrating a constitution in the third embodiment of a laser processing apparatus according to the present invention. The laser processing apparatus 3, shown in FIG. 3, processes, the same as in the foregoing first and second embodiments, the surfaces of processing objects 50 by irradiating the objects 50 with a laser beam. In concrete terms, the laser processing apparatus 3 according to the third embodiment comprises a laser light source 10, a galvano-scanner 200 as a scanning system, a lens 30 being a condenser optical system, a condensing direction modifier 46, and a common mount surface 55. The galvano-scanner 200 includes a galvano-mirror 20 and a driver 25 that changes the reflection angle of the galvano-mirror 20. The condensing direction modifier 46 has a first surface (the laser beam entrance surface) facing the lens 30 and a second surface (the laser beam exit surface) opposing the first surface, wherein a part (a part parallel with the first surface) of the second surface defines a reference surface 46a of the condensing direction modifier 46. The objects 50 are disposed on a fiat surface that is perpendicular to the optical axis of the lens 30, namely, on the common mount surface 55, in a state where the objects 50 are adjacent to each other. The laser processing apparatus 3 according to the third embodiment has the similar constitution as those in the first and second embodiments, except that the shape of the condensing direction modifier 46 is different from those of the condensing direction modifiers 40 and 43 in the first and second embodiment.

That is, the condensing direction modifier 46 of the laser processing apparatus 3 according to the third embodiment is comprised of a silica glass, having a uniform refractive index distribution. The condensing direction modifier 46 is different from the first and second embodiments in that the condensing direction modifier 46 is provided with Fresnel lens sections 47 at constant intervals on the reference surface 46a. The disposition intervals of these Fresnel lens sections 47 are 310 μm, the same as the first and second embodiments in that the disposition intervals are made equal to the disposition interval of the objects 50.

Here, the laser processing method according to the third embodiment will be described, referring to FIG. 3. The description below will be made focusing on the operation of the condensing direction modifier 46, in other words, focusing on the state where a laser beam is condensed at a condensed point, the distance of which from the lens 30 with respect to the optical axis direction is different, according to the position where the laser beam is inputted.

First, a laser beam L6 will be described. The laser beam L6 (a laser beam outputted from the laser light source 10), shown in FIG. 3, is reflected by the galvano-mirror 20 and then arrives at the lens 30. The laser beam L6 is outputted by the lens 30 such as to be condensed, and then enters the condensing direction modifier 46.

The condensing direction modifier 46 is comprised of a silica glass. Consequently, the laser beam L6 inputted to the condensing direction modifier 46 travels through the condensing direction modifier 46, being refracted according to the refractive index of the silica glass. Then, this laser beam L6 is outputted from a flat plate part (corresponding to the reference surface 46a) of the condensing direction modifier 46. Herein, since the refractive index of the condensing direction modifier 46 is greater than the atmospheric refractive index, the laser beam L6 outputted from the condensing direction modifier 46 is condensed at a position farther than the back focal plane of the lens 30 from the lens 30 with respect to the optical axis direction. Accordingly, the condensed point of the laser L6 can be modified to a position different from the back focal plane of the lens 30.

Next, laser beams L7 and L8 which pass through Fresnel lens sections 47 of the condensing direction modifier 46 will be described. The laser beams L7 and L8 (laser beams outputted from the laser light source 10), as shown in FIG. 3, are reflected, the same as the laser beam L6, by the galvano-mirror 20, and then arrive at the lens 30. The laser beams L7 and L8 are outputted in a state where they are condensed by the lens 30, and enter the condensing direction modifier 46.

Herein, the condensing direction modifier 46 is comprised of a silica glass. Consequently, the laser beams L7 and L8 inputted to the condensing direction modifier 46 respectively travel through the condensing direction modifier 46, being refracted according to the refractive index of the silica glass. Then, the laser beams L7 and L8 travel to a Fresnel lens section 47 of the condensing direction modifier 46, and exit from the condensing direction modifier 46. Herein, the surface of the Fresnel lens section 47 that outputs the laser beams L7 and L8 have angles which are different from that of the face (the surface parallel to the reference surface 46a) where the laser beams L7 and L8 have entered. Accordingly, the output directions of the laser beams L7 and L8, which are outputted from the surface of the Fresnel lens section 47, are respectively different from the optical axis direction of the lens 30. Further, since the refractive index of the condensing direction modifier 46 is greater than the ambient refractive index, the laser beams L7 and L8, which are outputted from the condensing direction modifier 46, are condensed at positions farther than the back focal plane of the lens 30 from the lens 30 with respect to the optical axis direction. In such a manner, the condensed positions of the laser beams L7 and L8 can be modified to positions which are different from the back focal plane of the lens 30.

Still further, the condensed position of a laser beam is different according to the thickness, with respect to the optical axis direction of the lens 30, of the condensing direction modifier 46. Accordingly, the distances from the lens 30 to the condensed positions are respectively different between the laser beam L6, L7, and L8, wherein the laser beam L6 passes through the flat plate part of the condensing direction modifier 46, and the laser beams L7 and L8 pass through the Fresnel lens section 47 of the condensing direction modifier 46.

As shown in FIG. 3, the condensing direction modifier 46 is arranged such that the parts in a shape of a flat plate of the condensing direction modifier 46 are positioned above the top surface portions of the objects 50, and the Fresnel lens sections 47 are positioned above the side surfaces of the objects 50. Thus, the following effects can be obtained. That is, the side surfaces of the objects 50 can be processed by the laser beams L7 and L8 which have passed through a Fresnel lens section 47. Further, the top surfaces of the objects 50 can be processed by a laser L6 having passed through the part in the shape of a flat plate.

In accordance with the third embodiment, the condensing direction of a laser beam can be modified; the condensed position of a laser beam can be modified to a position that is different from the back focal plane of the lens; and further, objects having a complicated shape can also be irradiated in a state where a laser beam is condensed. Thus, desired objects can be sufficiently laser processed.

Respective embodiments according to the present invention have been described above. However, the present invention is not limited to the foregoing embodiments, and various changes and modifications can be made.

For example, regarding the prism sections 41 included in the condensing direction modifier 40 in the first embodiment, the angle formed by two faces of each prism section 41, and the thickness of each prism section 41 at the vertex thereof with respect to the optical axis direction of the lens 30, can be modified, and thereby the condensed position of a laser beam can be adjusted. Likewise, for the concave lens sections 44 included in the condensing direction modifier 43 in the second embodiment, the condensed position of a laser can be adjusted by modifying the diameter or the curvature of the lenses. Further, for the Fresnel lens sections 47 included in the condensing direction modifier 46 in the third embodiment, the condensed position of a laser can be adjusted by modifying the diameter or the curvature of the lenses, or the structure of the cross-section in a saw-toothed shape.

Further, in the first to third embodiments, for the objects 50, a state where two coaxial cables are disposed on a common mount surface 55 is shown, however, the number of coaxial cables to be disposed is not limited. In a case where three or more objects 50, such as coaxial cables, are disposed, effects similar to those of the foregoing respective embodiments can be obtained by modifying the shapes of the condensing direction modifiers 40, 43, and 46, corresponding to the number of objects 50.

As has been described above, in accordance with the present invention, using a laser condensing direction modifier, it is possible to condense a laser beam at a condensed point that is different from the condensed point by a lens. Thus, more effective laser processing can be realized even for objects having a complicated shape.

What is claimed is:

1. A laser processing method of processing respective plural objects disposed in an array on a predetermined flat surface by irradiating the plural objects with a laser beam, while scanning an irradiation position of the laser beam, the laser processing method comprising the steps of:
disposing the plural objects at predetermined positions on the common mount surface, in a state where the plural objects are adjacent to each other;
sequentially outputting the laser beam from the light source onto the plural objects along a vertical direction to the common mount surface, while scanning the laser beam along a horizontal direction to the common mount surface; and
by using a condensing direction modifier disposed over each of the plural objects, changing a condensing direction of the vertically outputted laser beam according to a position where the laser beam is outputted from the condensing direction modifier.

2. A laser processing apparatus for processing respective plural objects disposed in an array on a predetermined flat surface, by irradiating the plural objects with a laser beam, while scanning an irradiation position of the laser beam, the laser processing apparatus comprising:
a common mount surface on which the plural objects are disposed in a state where the plural objects are adjacent to each other;
a light source for outputting the laser beam;
a galvano-scanner outputting the laser beam from the light source toward the common mount surface, while scanning the laser beam along a horizontal direction to the common mount surface;
a condenser optical system provided between the galvano-scanner and the common mount surface, the condenser optical system condensing the laser beam arrived from the galvano-scanner such that the laser beam is outputted toward the common mount surface along a vertical direction to the common mount surface; and
a condensing direction modifier provided between the condenser optical system and the common mount surface, the condensing direction modifier, according to a position where the laser beam arrives from the condenser optical system, outputting the arrived laser beam along a direction that is different from a principal beam direction of the arrived laser beam.

3. A laser processing apparatus according to claim 2, wherein the condensing direction modifier has a uniform refractive index distribution, and a thickness along an optical axis direction of the condenser optical system is different according to a position where the laser beam from the mirror arrives.

4. A laser processing apparatus according to claim 3, wherein the condensing direction modifier has a first surface facing the condenser optical system and a second surface opposing the first surface, and
wherein at least a part of the second surface has a prism shape including two surfaces having respective different angles with respect to a reference surface of the second surface.

5. A laser processing apparatus according to claim 3 wherein the condensing direction modifier has a first surface facing the condenser optical system and a second surface opposing the first surface, and
wherein at least a part of the second surface has a shape of a concave lens.

6. A laser processing apparatus according to claim 3, wherein the condensing direction modifier has a first surface facing the condenser optical system and a second surface opposing the first surface, and
wherein at least a part of the second surface has a shape of a Fresnel lens.
